(19) United States
(12) Patent Application Publication
(10) Pub. No.: US 2010/0135703 A1
(43) Pub. Date: Jun. 3, 2010

(54) Transfer Apparatus and Image Forming Apparatus

(75) Inventors: Masahide NAKAMURA, Matsumoto-shi (JP); Ken IKUMA, Suwa-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/621,323

(22) Filed: Nov. 18, 2009

(30) Foreign Application Priority Data
Nov. 28, 2008 (JP) 2008-303580

(51) Int. Cl. G03G 15/16

(52) U.S. Cl. 399/313

(57) ABSTRACT

A transfer apparatus includes a transfer belt that has a volume resistivity of 10⁹ to 10¹² Ω·cm and carries a liquid developer including a carrier liquid and toner particles with conductivity equal to or greater than 1 pS/cm and equal to or less than 100 pS/cm in a first surface thereof. A first roller is grounded and is in contact with a second surface of the transfer belt. A second roller is in contact with the second surface of the transfer belt. A third roller is in contact with the first surface of the transfer belt and presses the first roller with the transfer belt interposed therebetween. A voltage source applies a voltage to the third roller.

### CROSS-REFERENCE TO RELATED APPLICATIONS

This application claims the benefit of priority under 35 USC 119 of Japanese application no. 2008-303580, filed on Nov. 28, 2008, which is incorporated herein by reference.

### BACKGROUND

1. Technical Field

The present invention relates to a transfer apparatus for developing a latent image formed on a photosensitive body by a liquid developer formed of a toner and a carrier and transferring the developed image onto a medium such as recording paper. In addition, the present invention relates to an image forming apparatus using such a transfer apparatus.

2. Related Art

Various wet-type image forming apparatuses for developing a latent image using a liquid developer with high viscosity, in which toner particles formed of a solid component are dispersed in a liquid solvent, and making an electrostatic latent image visible have been suggested. A developer used in a wet-type image apparatus is obtained by suspending solids (toner particles) in an organic solvent (carrier liquid) with high viscosity and an electrical insulation property. The carrier liquid is formed of silicon oil, mineral oil, edible oil or the like, and the toner particles are fine with a particle diameter of about 1 μm. By using fine toner particles, a wet-type image forming apparatus realizes higher image quality compared with a dry-type image forming apparatus using powder toner particles with a particle diameter of about 7 μm.

However, in an image forming apparatus using a liquid developer, transfer (secondary transfer) efficiency onto paper deteriorates in a printing method using the liquid developer and, more particularly, in a method for superposing a plurality of colors on an intermediate transfer belt and then the colors on paper (recording medium) once.

In order to solve this problem, for example, JP-A-2001-166611 suggests a method for winding a transfer belt on a secondary transfer roller so as to hustle a nip length in a secondary transfer portion to some extent and increasing a time when contact force and a transfer electrical field is applied between a recording medium and a transfer belt so as to increase a transfer efficiency.

In JP-A-2001-166611, if a certain length is secured as the nip length of the secondary transfer portion and an electrical field is continuously applied over the nip length, the toner particles in the liquid developer are held in an electrical field for a relatively long time, the injection of electrical charge with a polarity opposite to that of the toner is received from the secondary transfer roller side, and a phenomenon in which the polarity of the toner particles is reversed occurs. Such a phenomenon more remarkably occurs if the liquid developer (toner particles and a liquid component) has high conductivity. This is because, if the conductivity of the toner layer during transfer is high, an electrical charge is apt to be exchanged with a member (the intermediate transfer belt or the paper) with which the toner particles are in contact and thus the injection of an electrical charge more actively occurs. In addition, if the conductivity of the liquid component is complemented, the conductivity of the carrier liquid is low, but the conductivity of the liquid component is changed by the other material soluble in the carrier liquid.

If the nip length of the secondary transfer portion is relatively long as in the known technology, the phenomenon in which the polarity of the toner particles is reversed within the secondary transfer nip occurs, and transfer efficiency deteriorates. In particular, if a liquid developer (toner particles and a liquid component) with high conductivity is used, transfer efficiency deteriorates remarkably.

### SUMMARY

According to an aspect of the invention, a transfer apparatus is provided including: a transfer belt that has a volume resistivity of 10⁹ to 10¹² Ω·cm and carries a liquid developer including a carrier liquid and toner particles with conductivity equal to or greater than 1 pS/cm and equal to or less than 100 pS/cm in a first surface thereof; a first roller that is grounded and is in contact with a second surface of the transfer belt; a second roller that is in contact with the second surface of the transfer belt; a third roller that is in contact with the first surface of the transfer belt and presses the first roller with the transfer belt interposed therebetween; and a voltage source that applies a voltage to the third roller.

In the transfer apparatus of the invention, the surface resistance of the first surface of the transfer belt may be 10^{9.5} to 10^{12.5}Ω.

In the transfer apparatus of the invention, the transfer belt may have a base layer configuring the second surface and an elastic and a surface layer configuring the first surface.

In the transfer apparatus of the invention, the third roller may press the second roller with the transfer belt interposed therebetween.

The transfer apparatus of the invention may further include a second voltage source that applies a voltage, having a voltage value equal to or substantially equal to that of a voltage applied to the third roller, to the second roller.

In the transfer apparatus of the invention, the second roller may be electrically in a float state.

According to another aspect of the invention, an image forming apparatus is provided including: a latent image carrier on which a latent image is formed; a charging unit that charges the latent image carrier; an exposure unit that forms the latent image on the latent image carrier charged by the charging unit; a development unit that develops the latent image formed on the latent image carrier by the exposure unit using a liquid developer including a carrier liquid and toner particles with conductivity equal to or greater than 1 pS/cm and equal to or less than 100 pS/cm; a transfer belt with a volume resistivity of 10⁹ to 10¹² Ω·cm, in which an image developed by the development unit is transferred onto a first surface thereof; a first roller that is grounded and is in contact with a second surface of the transfer belt; a second roller that is in contact with the second surface of the transfer belt; a third roller that is in contact with the first surface of the transfer belt and presses the first roller with the transfer belt interposed therebetween so as to transfer the image onto a recording medium; and a voltage source that applies a voltage to the third roller.

In the image forming apparatus of the invention, the third roller may press the second roller with the transfer belt interposed therebetween.

According to the transfer apparatus and the image forming apparatus of the invention, the nip length of a secondary transfer portion is relatively long and a time when pressure is applied between the recording medium and the transfer belt can be secured to a certain extent. Accordingly, it is possible to improve transfer efficiency. In addition, even when the nip length of the secondary transfer portion is relatively long, since an electrical field in a nip is applied only to a nip area formed by the first roller and the third roller, it is possible to prevent the phenomenon in which the polarity of the toner particles is reversed and prevent the transfer efficiency from being reduced because of that phenomenon.

### BRIEF DESCRIPTION OF THE DRAWINGS

The invention will be described with reference to the accompanying drawings, wherein like numbers reference like elements.

FIG. 1 is a view of the main components of an image forming apparatus according to an embodiment of the invention.

FIG. 2 is a cross-sectional view showing the main components of an image forming portion.

FIG. 3 is a view showing the main components of a secondary transfer unit, which is a transfer apparatus according to a first, embodiment of the invention.

FIG. 4 is a view showing the cross-sectional structure of a transfer belt of the secondary transfer unit.

FIG. 5 is a view showing the main components of a secondary transfer unit, which is a transfer apparatus according to a second embodiment of the invention.

FIG. 6 is a view showing an equivalent circuit used for calculating conductivity of a liquid developer.

FIG. 7 is a graph showing a transfer efficiency change according to a transfer voltage change.

FIG. 8 is a graph showing a transfer efficiency change according to a transfer voltage change.

FIG. 9 is a graph showing a transfer efficiency change according to a transfer voltage change.

FIG. 10 is a graph showing a transfer efficiency change according to a transfer voltage change.

### DESCRIPTION OF EXEMPLARY EMBODIMENTS OF THE INVENTION

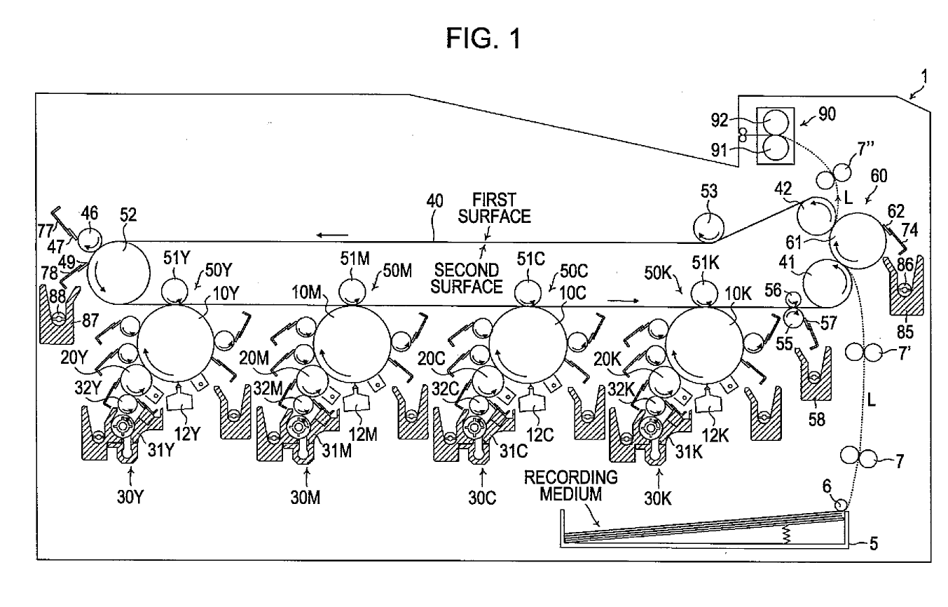

Hereinafter, embodiments of the invention will be described with reference to the accompanying drawings. FIG. 1 is a view of the main components of an image forming apparatus 1 according to an embodiment of the invention. With respect to image forming portions of respective colors arranged on a central portion of the image forming apparatus 1, development devices 30Y, 30M, 30C and 30K are disposed on the lower side of the image forming apparatus, and a transfer belt 40 and a secondary transfer portion (secondary transfer unit) 60 are disposed on the upper side of the image forming apparatus.

The image forming portions include photosensitive bodies 10Y, 10M, 10C and 10K, corona chargers 11Y, 11M, 11C and 11K, and, exposure units 12Y, 12M, 12C and 12K. Each of the exposure units 12Y, 12M, 12C and 12K includes an organic EL element array (or an LED array), a driver IC, and a wiring substrate. The photosensitive bodies 10Y, 10M, 10C and 10K are uniformly charged by the corona chargers 11Y, 11M, 11C and 11K, and the exposure units 12Y, 12M, 12C and 12K are controlled based on an input image signal, thereby forming electrostatic latent images on the charged photosensitive bodies 10Y, 10M, 10C and 10K.

The development devices 30Y, 30M, 30C and 30K respectively include developer containers (reservoirs) 31Y, 31M, 31C and 31K for storing liquid developers of respective colors of yellow (Y), magenta (M), cyan (C) and black (K) and anilox rollers 32Y, 32M, 32C and 32K, which are coating rollers for applying the liquid developers of the respective colors from the developer containers 31Y, 31M, 31C and 31K to the development rollers 20Y, 20M, 20C and 20K, and develop electrostatic latent images on the photosensitive bodies 10Y, 10M, 10C and 10K by the liquid developers of the respective colors.

The transfer belt 40 is an endless belt stretched over a driving roller 41 and tension rollers 52 and 53, and is rotated by the driving roller 41 while being in contact with the photosensitive bodies 10Y, 10M, 10C and 10K at primary transfer portions SOY, 50M, 50C and 50K. In the primary transfer portions 50Y, 50M, 50C and 50K, primary transfer rollers 51Y, 51M, 51C and 51K respectively face the photosensitive bodies 10Y, 10M, 10C and 10K with the transfer belt 40 interposed therebetween, the contact positions thereof with the photosensitive bodies 10Y, 10M, 100 and 10K become transfer positions, and the toner developed images of the respective colors on the developed photosensitive bodies 10Y, 10M, 10C and 10K are sequentially transferred onto the transfer belt 40 so as to overlap with each other, thereby forming a full-color toner developed image. The transfer belt 40 has a first surface and a second surface, and the toner developed images are carried on the first surface.

In the secondary transfer unit 60, a secondary transfer roller 61 faces the driving roller 41 and a second roller 42 with the transfer belt 40 interposed therebetween. A cleaning device including a secondary transfer roller cleaning blade 62 is provided. At the transfer position where the secondary transfer roller 61 is disposed, a single-color toner image or a full-color toner image formed on the transfer belt 40 is transferred onto a recording medium transported on a sheet material transportation path L, such as paper, film or cloth.

In the image forming apparatus 1, the sheet material set in a paper feed cassette 5 is picked up by a pickup roller 6 one by one at a predetermined timing and is transported onto the sheet material transportation path L. On the sheet material transportation path L, a sheet material is transported to the secondary transfer position by transportation roller pairs 7 and 7′, and a single-color toner developed image or a full-color toner developed image formed on the transfer belt 40 is transferred onto the sheet material. The secondary transferred sheet material is further transported to a fixing portion 90 by a transportation roller pair 7″. The fixing portion 90 includes a heating roller 91 and a pressurization roller 92 energized to the heating roller 91 with predetermined pressure. A sheet material, such as paper, is inserted into a nip therebetween and the single-color toner image or the full-color toner image transferred onto the sheet is fused and fixed on the sheet material.

The tension roller 52 stretches the transfer belt 40 together with the driving roller 41 and the like, and is in contact with a cleaning device including a transfer belt cleaning roller 46 at a place where the transfer belt 40 is stretched over the tension roller 52.

The transfer belt 40 passing the secondary transfer unit 60 is circulated in order to receive a transferred image at the primary transfer portion 50, and the transfer belt 40 is cleaned by the transfer belt cleaning roller 46 or the like on the upstream side in which the primary transfer portion 50 is executed.

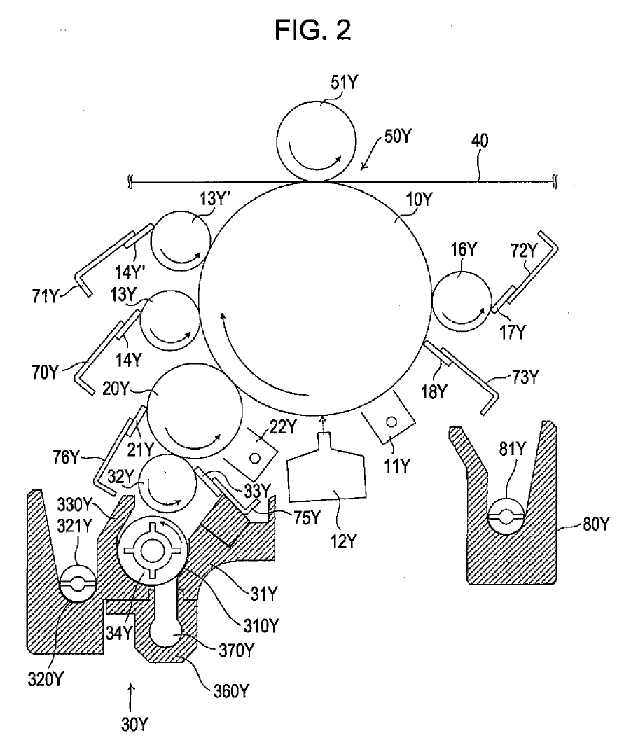

Next, each of the image forming portions and each of the development devices of the image forming apparatus 1 according to the embodiment of the invention will be described. FIG. 2 is a cross-sectional view showing the main components of an image forming portion and a development device. Since the image forming portions and the development devices of the respective colors are the same, hereinafter, only the image forming portion and the development device of yellow (Y) will be described.

In the image forming portion, a photosensitive body cleaning roller 16Y, a photosensitive body cleaning blade 18Y, a corona charger 11Y, an exposure unit 12Y, a development roller 20Y of the development device 30Y, a first photosensitive body squeeze roller 13Y, and a second photosensitive squeeze roller 13Y′ are arranged along the rotation direction of the outer circumference of a photosensitive body 10Y.

The photosensitive body cleaning roller 16Y is a roller having a urethane rubber surface layer and is rotated in a counterclockwise direction while being in contact with the photosensitive body 10Y so as to clean a transfer remaining liquid developer or a non-transfer liquid developer on the photosensitive body 10Y. A bias voltage for attracting toner particles in the liquid developer is applied to the photosensitive body cleaning roller 16Y. To this end, a liquid developer in which a large number of toner particles is included is recovered by the photosensitive body cleaning roller 16Y. The solids-rich liquid developer recovered by the photosensitive body cleaning roller 16Y is scraped by a photosensitive body cleaning roller cleaning blade 17Y that is in contact with the photosensitive body cleaning roller 16Y so as to drop in a vertical direction.

In contrast, on the downstream side of the photosensitive body cleaning roller 16Y, the photosensitive body cleaning blade 18Y that is in contact with the photosensitive body 10Y drops the carrier-components-rich liquid developer onto the photosensitive body 10Y through a cleaning blade holding member 73Y downward.

“Solids rich” refers to the state of a liquid developer in which a larger amount of solids is included, compared with a liquid developer supplied to the development device 30Y. In contrast, “carrier components rich” refers to the state of a liquid developer in which a larger amount of carrier components is included, compared with the liquid developer supplied to the development device 30Y. In addition, the liquid developer (toner) may be defined as that in which solids (toner particles) are dispersed in the carrier.

In the cleaning blade holding member 73Y, the solids-rich liquid developer dropped from the photosensitive body cleaning roller cleaning blade 17Y and the carrier-components-rich liquid developer scraped from the photosensitive body cleaning blade 18Y are mixed so as to improve a transportation property. The improvement of the transportation property may contribute to the downsizing of the apparatus.

A photosensitive recovery reservoir 80Y includes a concave portion which receives both the solids-rich liquid developer scraped by the photosensitive body cleaning roller cleaning blade 17Y and the carrier-components-rich liquid developer scraped by the photosensitive body cleaning blade 18Y.

A recovery screw 81Y is provided in the concave portion of the photosensitive body recovery reservoir 80Y. By rotating the recovery screw 81Y, the spiral vanes thereof transport the liquid developer received by the concave portion in the rotation axis direction of the recovery screw 81Y. The liquid developer transported to the recovery screw 81Y is delivered to a recovery mechanism.

Reference numerals 70Y, 71Y, 72Y and 73Y denote cleaning blade holding members for holding the cleaning blades.

A cleaning blade 21Y, an anilox roller 32Y and a compaction corona generator 22Y are arranged on the outer circumference of the development roller 20Y of the development device 30Y. A regulation blade 33Y for regulating the amount of liquid developer supplied to the development roller 20Y is in contact with the anilox roller 32Y. A blade holding member 75Y holds the regulation blade 33Y. An auger 34Y and a recovery screw 321Y are received in the liquid developer container 31Y.

The primary transfer roller 51Y of the primary transfer portion is disposed at a position facing the photosensitive body 10Y along the transfer belt 40.

The photosensitive body 10Y is a photosensitive drum formed of a cylindrical member with a width larger than that of the development roller 20Y and having a photosensitive layer formed on the outer circumferential surface thereof, and is rotated in a clockwise direction as shown in FIG. 2. The photosensitive layer of the surface layer of the photosensitive body 10Y is composed of an amorphous silicon photosensitive body. The corona charger 11Y is disposed on the upstream side of the rotation direction of the photosensitive body 10Y from the nip portion of the photosensitive body 10Y and the development roller 20Y, and receives a voltage from a power source device so as to corona-charge the photosensitive body 10Y. The exposure unit 12Y irradiates a laser beam onto the photosensitive body 10Y charged by the corona charger 11Y so as to form the latent image on the photosensitive body 10Y, on the downstream side of the rotation direction of the photosensitive body 10Y from the corona charger 11Y.

In this description, from the beginning to the end of an image forming process, a roller or the like disposed in a pre-stage is positioned on an “upstream” side from a roller or the like disposed in a post-stage.

The development device 30Y has the compaction corona generator 22Y for performing a compaction operation and the developer container 31Y for storing the liquid developer in which toner particles are dispersed in the carrier with a weight ratio of about 20%. In the developer container 31Y, the recovery screw 321Y for recovering the liquid developer or the like, which is not supplied to the anilox roller 32Y is also included.

The development device 30Y has the development roller 20Y for carrying the liquid developer, the anilox roller 32Y which is a coating roller for applying the liquid developer to the development roller 20Y, the regulation blade 33Y for regulating the amount of liquid developer applied to the development roller 20Y, the auger 34Y for supplying the liquid developer to the anilox roller 32Y while stirring and transporting the liquid developer, the compaction corona generator 22Y for compacting the liquid developer carried in the development roller 20Y, and the development roller cleaning blade 21Y for cleaning the development roller 20Y. Cleaning blade holding member 76Y holds the development roller cleaning blade 21Y.

The liquid developer received in the developer container 31Y is not a volatile liquid developer using Isopar (trademark: Exxon), which is generally used as the carrier, with low concentration (about 1 to 2 wt %) and low viscosity, and having volatility at room temperature, but is a nonvolatile liquid developer with high concentration and high viscosity and having non-volatility at room temperature.

That is, the liquid developer of the invention is a liquid developer with high viscosity (about 30 to 10000 mPa·s) and a toner solid concentration of about 20%, which is obtained by adding solids with an average particle diameter of 1 μm, in which a coloring agent such as a pigment is dispersed in a thermoplastic resin, to a liquid solvent such as an organic solvent, silicon oil, mineral oil or edible oil together with a dispersing agent. Although the toner particles are positively charged in the present embodiment, the invention can use toner particles that are negatively charged. In this case, the polarity of the applied bias voltage is reversed.

The liquid developer used in the invention has conductivity equal to or greater than 1 pS/cm and equal to or less than 100 pS/cm. The reason that the liquid developer has such conductivity is because the charging amount of the toner particles can be set sufficiently high by setting the conductivity to be equal to or greater than 1 pS/cm and thus good development property and transfer property can be obtained. The reason that an upper limit is set is because, if the conductivity is greater than 100 pS/cm, a development current value is increased excessively such that development failure occurs, image flow occurs on the photosensitive body such that a phenomenon in which image resolution deterioration occurs, or inconvenience is caused in the image forming process on the upstream side from the transfer process.

In the liquid developer container 31Y, the auger 34Y is separated from the anilox roller 32Y. By rotating the auger 34Y in the counterclockwise direction as shown in FIG. 2, the liquid developer is supplied to the anilox roller 32Y.

The space in the development container 31Y is partitioned into two spaces by a partitioning portion 330Y. One of the spaces partitioned by the partitioning portion 330Y is used as a supply reservoir 310Y for supplying the liquid developer and the other thereof is used as the recovery reservoir 320Y for recovering the liquid developer. The supply reservoir 310Y and the recovery reservoir 320Y are partitioned by the partitioning portion 330Y so as to be parallel with each other in an axial direction.

The auger 34Y is rotatably provided in the supply reservoir 310Y. The auger 34Y is rotated when the apparatus is operated such that the liquid developer collected in the supply reservoir 310Y is supplied to the anilox roller 32Y. The supply reservoir 310Y and a liquid developer supply tube 370Y are connected, and the supply of the liquid developer to the supply reservoir 310Y is performed by the liquid developer supply tube 370Y.

The recovery screw 321Y is rotatably provided in the recovery reservoir 320Y. The recovery screw 321Y is rotated when the apparatus is operated such that the liquid developer which is not used for development or the carrier dropped from the cleaning blades such as the photosensitive body squeeze roller cleaning blades 14Y and 14Y′ are recovered.

The recovery reservoir 320Y and liquid developer recovery tube 371Y are connected, and the recovery screw 321Y is rotated such that the liquid developer is transported to one end of the recovery reservoir 320Y connected with the liquid developer recovery tube 371Y. The liquid developer recovered in the recovery reservoir 320Y is attracted to a liquid developer recycling mechanism by the liquid developer recovery tube 371Y.

The anilox roller 32Y functions as a coating roller for applying and supplying the liquid developer to the development roller 20Y. The anilox roller 32Y is a cylindrical member and is a roller in which an uneven surface is formed due to grooves that are finely and uniformly engraved in the surface in a spiral shape in order to carry easily the developer in the surface. By the anilox roller 32Y, the liquid developer is supplied from the developer container 31Y to the development roller 20Y. When the apparatus is operated, as shown in FIG. 2, the auger 34Y is rotated in the clockwise direction so as to supply the liquid developer to the anilox roller 32Y, and the anilox roller 32Y is rotated in the counterclockwise direction so as to apply the liquid developer to the development roller 20Y.

The regulation blade 331 is an elastic blade configured by coating the surface thereof with an elastic material, and includes a rubber portion that is in contact with the surface of the anilox roller 32Y and is formed of urethane rubber or the like, and a metal plate for supporting the rubber portion. The film thickness and amount of the liquid developer carried and transported by the anilox roller 32Y are regulated and adjusted and the amount of the liquid developer supplied to the development roller 20Y is adjusted.

The development roller cleaning blade 211 is in contact with the surface of the development roller 20Y and is formed of rubber or the like, and is disposed on the downstream side of the rotation direction of the development roller 20Y from the development nip portion in which the development roller 20Y is in contact with the photosensitive body 10Y, such that the liquid developer left on the development roller 20Y is scraped and removed.

The compaction corona generator 22Y is an electrical field applying unit for increasing the charging bias of the surface of the development roller 20Y. In the liquid developer transported by the development roller 20Y, as shown in FIG. 2, an electrical field is applied from the compaction corona generator 22Y toward the development roller 20Y at a compaction position.

As the electrical field applying unit for compaction, a compaction roller or the like may be used instead of the corona discharge of the corona discharger shown in FIG. 2. Such a compaction roller is a cylindrical member, is an elastic roller coated with an elastic material similar to the development roller 20Y, has a structure having a conductive resin layer or rubber layer on the surface layer of a metal roller base material, and is rotated in the clockwise direction opposite to that of the development roller 20Y.

Meanwhile, the developer that is carried and compacted in the development roller 20Y is developed in correspondence with the latent image of the photosensitive body 10Y by applying a desired electrical field in the development nip portion in which the development roller 20Y is in contact with the photosensitive body 10Y. A portion in which the developed image is present on the photosensitive body 10 developed by the liquid developer by the development roller 20Y is called an image portion, and a portion in which the developed image is not present is called a non-image portion.

The developer remaining after development is scraped and removed by the development roller cleaning blade 211 and is dropped to the recovery portion in the developer container 31Y so as to be reused. The reused carrier and toner are not in a color-mixed state.

The photosensitive body squeeze device disposed on the upstream side of the primary transfer is disposed on the downstream side of the development roller 20Y so as to face the photosensitive body 10Y, recovers extra developer on the toner image developed on the photosensitive body 10Y, includes a first photosensitive squeeze roller 13Y and a second photosensitive body squeeze roller 13Y′, each of which is composed of an elastic roller member that has a surface coated with an elastic material and slidably rotates in contact with the photosensitive body 10Y as shown in FIG. 2, and cleaning blades 14Y and 14Y′ that press and slide the first photosensitive body squeeze roller 13Y and the second photosensitive body squeeze roller 13Y′ and clean the surfaces thereof, and has a function for recovering extra carrier and originally unnecessary fogged toner from the developer developed on the photosensitive body 10Y and increasing a toner particle ratio in the developed image. Although a plurality of photosensitive body squeeze rollers 13Y and 13Y′ is provided as the photosensitive body squeeze device before primary transfer in the present embodiment, one photosensitive body squeeze roller may be used. In addition, one of the plurality of photosensitive body squeeze rollers 13Y and 13Y′ may abut or separate according to the liquid developer state or the like.

Each of the first photosensitive body squeeze roller 13Y and the second photosensitive body squeeze roller 13Y′ recovers unnecessary fogged toner by applying an adequate bias voltage value.

In the primary transfer portion 50Y, the developer image developed on the photosensitive body 10Y is transferred to the transfer belt 40 by the primary transfer roller 51Y. In the primary transfer portion, the toner image on the photosensitive body 10 is transferred to the transfer belt 40 by the action of the transfer bias Vt applied to the primary transfer backup roller 51. The photosensitive body 10Y and the transfer belt 40 move at the same velocity, reduce the driving load of the rotation and movement and suppress disturbance on the developed toner image of the photosensitive body 10Y.

The transfer belt 40 passes through the nip of the primary transfer portions 50 of yellow (Y), magenta (M), cyan (C) and black (K) such that the developed images of the respective colors on the photosensitive bodies and color superposition occur.

The transfer belt 40 on which the developed images of the respective colors are transferred is squeezed by the transfer belt squeeze device disposed at a pre-stage where the developed image enters the nip portion of the secondary transfer unit 60. The transfer belt squeeze device serves to recover extra carrier and originally unnecessary fogged toner from the developed image on the transfer belt 40 and increase the toner particle ratio in the developed image on the transfer belt 40.

The transfer belt squeeze device includes a transfer belt squeeze roller 55, a backup roller 56, and a transfer belt squeeze roller cleaning blade 57 on the downstream side of the movement direction of the transfer belt 40 of the development device 30K.

A transfer belt developer recovery portion 58 receives liquid developer dropped from the transfer belt squeeze roller cleaning blade 57, and a pipe for flowing the liquid developer from the blade is connected to the lower side of the transfer belt developer recovery portion 58.

The developed image on the transfer belt 40 enters the nip portion of the secondary transfer unit 60 after the toner particle ratio thereof is increased by the transfer belt squeeze device.

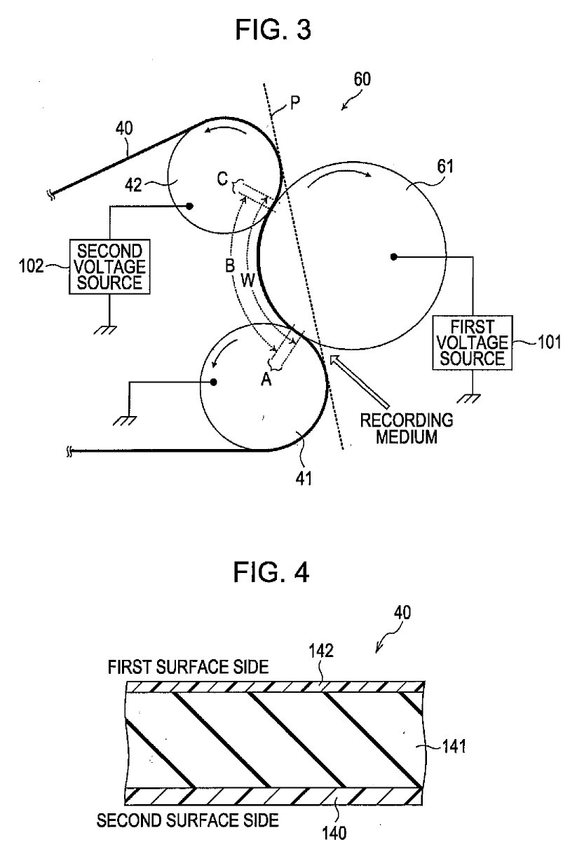

Now, the configuration of the transfer apparatus according to the embodiment of the invention will be described. FIG. 3 is a view showing the main components of the secondary transfer unit 60, which is a transfer apparatus according to the embodiment of the invention. The transfer apparatus according to the embodiment of the invention is characterized in that a nip area formed by the transfer belt 40 and the secondary transfer roller (third roller) 61 is included subsequently in a nip area formed by the driving roller 41 (also called “first roller”) and the secondary transfer roller 61 (also called “third roller”). In the present embodiment, a nip area formed by the second roller 42 and the secondary transfer roller (third roller) 61 is further included, but is not necessary. It is important that the nip area is present subsequently to the nip formed by the driving roller (first roller) 41 and the secondary transfer roller (third roller) 61. A series of nips in the secondary transfer unit 60 may be called a long nip.

The long nip will be described in detail. The secondary transfer unit 60 of the present embodiment has a series of nip areas including an area with a nip length A, which is formed by the driving roller (first roller) 41 and the secondary transfer roller (third roller) 61, an area with a nip length B, which is formed by the transfer belt 40 and the secondary transfer roller (third roller) 61, and an area with a nip length C, which is formed by the second roller 42 and the secondary transfer roller (third roller) 61, and the total length of the nip areas is W. In order to form the long nip area, in the transfer apparatus according to the invention, a layout in which the secondary transfer roller (third roller) 61 is disposed such that the secondary transfer roller (third roller) 61 is loaded on a virtual plan P tangent to the driving roller (first roller), 41 and the second roller 42 is taken.

The driving roller (first roller) 41 is grounded and held at a ground potential. In contrast, a predetermined bias voltage, for example, −2000 V, is applied to the secondary transfer roller (third roller) 61 by a first voltage source 101, and toner particles that are positively charged in the developed image are attracted from the transfer belt 40 to the recording medium side in the area with the nip length A. The same voltage value as the voltage applied to the secondary transfer roller (third roller) 61, for example, −2000 V, is applied to the second roller 42 by a second voltage source 102. The first voltage source 101 and the second voltage source 102 may be configured by the same voltage source.

The transfer belt 40 according to the present embodiment has relatively low resistivity in a belt thickness direction and high resistivity in a belt surface direction. From the above-described bias voltage relationship, a predetermined electrical field is applied in the nip and the movement (electrophoretic migration) of toner particles occurs in the area with the nip length A, but the electrical field is not present after the area with the nip length A and in the nip of the areas with the nip lengths B and C. Through the above-described configuration, the nip length of the secondary transfer portion is relatively long, and a time when pressure is applied between the recording medium and the transfer belt can be secured to a certain extent. Thus, it is possible to improve transfer efficiency. In addition, even when the nip length of the secondary transfer portion is relatively long, since the electrical field in the nip is applied only to the area with the nip length A, which is formed by the driving roller (first roller) 41 and the secondary transfer roller (third roller) 61, it is possible to prevent the phenomenon in which the polarity of the toner particles is reversed and prevent transfer efficiency from being reduced because of that phenomenon.

The reason that the nip length of the secondary transfer portion is set to relatively long is now described. As described up to now, in particular, in case of a liquid developer with high conductive property, when the secondary transfer nip is increased, there is a risk in which the polarity of the toner particles is reversed. In order to prevent the polarity of the toner particles from being reversed, good transfer efficiency is obtained when the nip length is set short so as to pass paper through the nip in a short time. This is due to the following reason.

The toner particles that enter the nip and receive the electrical field in the area with the nip length A are moved to the recording medium side by electrostatic force.

At this time, carrier oil is interposed between the recording medium and the toner particles. In particular, in fine concave portions of the surface of the recording medium, the toner particles and the surface of the recording medium are not sufficiently in contact with each other. When escaping from the nip in this state, some toner is present on the transfer belt 40, but on the recording medium.

In order to avoid it, if a nip passage time is increased and the transfer belt 40 and the recording medium are in contact with each other with a toner layer interposed therebetween, the carrier liquid is absorbed to the recording medium and thus the toner particles and the surface of the recording medium may be sufficiently in contact with each other. Thereafter, when the recording medium is ejected from the nip area, a good transfer property is obtained.

Now the transfer belt 40 will be described in more detail. The transfer belt 40 of the present embodiment has a multi-layer belt structure in which an intermediate layer of an elastic layer 141 formed of polyurethane is formed on a polyimide base layer 140 and a fluorine-based resin surface layer 142 is provided thereon. Such a transfer belt 40 is stretched on the driving roller 41, the second roller 42 and the tension roller 52 at the polyimide base layer side (second surface side) such that the toner image is transferred thereon at the fluorine-based resin surface layer 142 side (first surface side). Since the transfer belt 40 having elasticity has a good following property and responsiveness to the surface of the recording medium, toner particles with a small particle diameter are inserted into the fine concave portions of the recording medium during secondary transfer such that transfer is efficiently performed.

In the present embodiment, since the transfer belt 40 has a three-layer structure as described above and the Young's modulus of the base layer 140 is high, it is possible to prevent the transfer belt 40 from being elongated and prevent resist misalignment when an image is transferred from the photosensitive body. By providing the elastic layer 141, the surface of the transfer belt 40 is apt to follow the fine irregularities of the recording medium in the nip portion of the driving roller (first roller) 41 and the secondary transfer roller (third roller) 61 and the toner particles and the surface of the recording medium are apt to be in contact with each other. Thus, the transfer property is improved. By providing the surface layer 142, the separation property of the toner particles from the transfer belt 40 can be increased and the surface resistance of the side of the transfer belt 40, with which the toner particles are in contact, can be adequately set.

The volume resistivity of the transfer belt 40 according to the present embodiment is set to 10⁹ to 10¹² Ω·cm. The reason that such setting is suitable is because the current in the electrical field nip (area A) of the secondary transfer portion is suppressed and the polarity of the toner can be prevented from being reversed by setting the volume resistivity to 10⁹ Ω·cm or more. The reason that the upper limit is set is because, when the volume resistivity is greater than 10¹³ Ω·cm, the voltage drop of the transfer belt 40 in the electrical field nip (area A) of the secondary transfer portion is increased and thus an electrical field with a sufficient level cannot be formed and transfer failure occurs.

In the secondary transfer unit 60 of the invention, the second voltage source 102 may be omitted. In this case, the second roller 42 is electrically in a float state without being grounded. If the second roller 42 is electrically in the float state, the potential of the second roller 42 is equal to that of the secondary transfer roller (third roller) 61 due to the property of the transfer belt 40, of which the resistivity is relatively low in the belt thickness direction and is high in the belt surface direction. Accordingly, even when the second roller 42 is electrically in the float state, the electrical field in the nip is applied to only the area with the nip length A, which is formed by the driving roller (first roller) 41 and the secondary transfer roller (third roller) 61 so as to prevent the phenomenon in which the polarity of the toner particles is reversed and prevent transfer efficiency from being reduced because of that phenomenon.

Next, the condition of the surface resistance of the transfer belt 40 of the secondary transfer unit 60 according to the present embodiment will be described. In the invention, the surface resistance of the first surface of the transfer belt 40 is preferably set to 10^{9.5} to 10^{12.5}Ω. The reason that such a setting is preferable is because it is possible to prevent current from flowing in the circumferential direction of the transfer belt 40 by setting the surface resistance of the transfer belt 40 to 10^{9.5} or more. To this end, an electrical field is formed in only a portion in which the driving roller (first roller) 41 and the secondary transfer roller (third roller) 61 are in contact and an electrical field is not formed between the driving roller (first roller) 41 and the second roller 42. Thus, it is possible to prevent the electrical field from being unnecessarily applied to the toner particle layer in a long period of time.

According to the transfer apparatus and the image forming apparatus using the embodiment of the invention configured above, the nip length of the secondary transfer portion is relatively long and the time that pressure is applied between the recording medium and the transfer belt can be secured to a certain extent. Accordingly, it is possible to improve transfer efficiency. In addition, even when the nip length of the secondary transfer portion is relatively long, since the electrical field in the nip is applied only to the area with the nip length A, which is formed by the driving roller (first roller) 41 and the secondary transfer roller (third roller) 61, it is possible to prevent the phenomenon in which the polarity of the toner particles is reversed and prevent the transfer efficiency from being reduced because of that phenomenon.

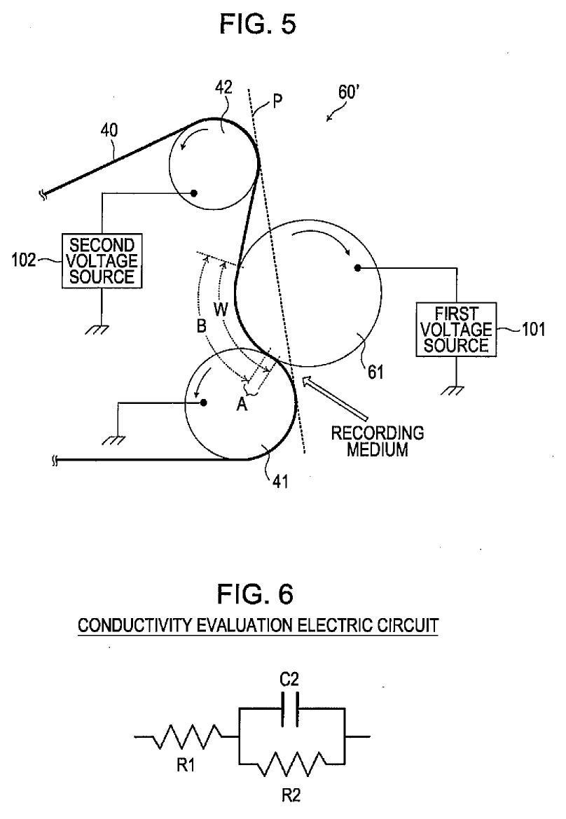

Next, a second embodiment of the invention will be described. FIG. 5 is a view showing the main components of a secondary transfer unit 60′, which is a transfer apparatus according to another embodiment of the invention. In FIG. 5, components denoted by the same reference numerals as in the first embodiment are the same as those components. The physicality of the liquid developer (toner particles) or the transfer belt 40 used in the second embodiment is the same as that of the first embodiment.

The second embodiment is different from the first embodiment in the arrangement relationship among the driving roller (first roller) 41, the second roller 42 and the secondary transfer roller (third roller) 61, and thus the nip lengths are different from each other. In the second embodiment, an area with a nip length A, which is formed by the driving roller (first roller) 41 and the secondary transfer roller (third roller) 61 and an area with a nip length B, which is formed by the transfer belt 40 and the secondary transfer roller (third roller) 61, are included, and the total length of the nip areas is W.

That is, although the total length W of the nip areas of the first embodiment includes the area with the nip length C, which is formed by the second roller 42 and the secondary transfer roller (third roller) 61, the area with the nip length C is not provided in the second embodiment.

Even in the second embodiment, the driving roller (first roller) 41 is grounded and held at a ground potential. In contrast, a predetermined bias voltage, for example, −2000 V, is applied to the secondary transfer roller (third roller) 61 by a first voltage source 101, and toner particles that are positively charged in the developed image are attracted from the transfer belt 40 to the recording medium side in the area with the nip length A. The same voltage value as the voltage applied to the secondary transfer roller (third roller) 61, for example, −2000. V, is applied to the second roller 42 by a second voltage source 102. In addition, the first voltage source 101 and the second voltage source 102 may be configured by the same voltage source.

In the secondary transfer unit 60 of the second embodiment, the second voltage source 102 may be omitted. In this case, since the second roller 42 is electrically in a float state without being grounded, the same effect as when the same voltage value as the secondary transfer roller (third roller) 61 is applied is obtained. Initially, the second roller 42 does not have a charge and has a voltage of 0 V. By applying a voltage to the secondary transfer roller (third roller) 61 so as to drive the belt, charges are slightly moved to the second roller 42 and thus the second roller 42 has substantially the same potential as the secondary transfer roller (third roller) 61.

In addition, the second roller 42 may be grounded. Due to the property of the transfer belt 40, of which the resistivity is relatively low in the belt thickness direction and is high in the belt surface direction, even when the second roller 42 is grounded, current hardly flows from the secondary transfer roller (third roller) 61 to the second roller 42 in the belt surface direction. Accordingly, even when the second roller is grounded, the electrical field in the nip is applied only to the area with the nip length A, which is formed by the driving roller (first roller) 41 and the secondary transfer roller (third roller) 61 so as to prevent the phenomenon in which the polarity of the toner particles is reversed and prevent transfer efficiency from being reduced because of that phenomenon.

According to the transfer apparatus and the image forming apparatus using the second embodiment of the invention configured above, the nip length of the secondary transfer portion is relatively long and a time when pressure is applied between the recording medium and the transfer belt can be secured to a certain extent. Accordingly, it is possible to improve transfer efficiency. In addition, even when the nip length of the secondary transfer portion is relatively long, since the electrical field in the nip is applied to only the area with the nip length A, which is formed by the driving roller (first roller) 41 and the secondary transfer roller (third roller) 61, it is possible to prevent the phenomenon in which the polarity of the toner particles is reversed and prevent the transfer efficiency from being reduced because of that phenomenon.

Next, examples of a transfer apparatus and an image forming apparatus according to the invention will be described.

### About Preparation of Liquid Developer

The toner particles were prepared in the following order.

| | |
|---|---|
| Polyester resin (Elitel UE3220 manufactured by | 500 g |
| Unitika Ltd.) | |
| Pigment Red 122 (Fastogen Super Magenta R | 200 g |
| manufactured by DIC Corporation) | |

After the above materials were mixed by a Hansel Mixer, the materials were kneaded at 90° C. for 40 minutes using two roll kneading machines. The kneaded material was pulverized to a particle size of about 1 mm by a cutter mill.

| | |
|---|---|
| Pulverized material | 500 g |
| Aluminum stearate powder | 15 g |
| Silicon oil (KF-413 manufactured by Toray | 1750 g |
| Dow Corning Corporation) | |

The above materials were inserted into Attritor and were pulverized and dispersed at 30° C. for 4 hours so as to obtain an undiluted solution of a liquid developer with a solid concentration of 22% and an average particle diameter of 1.5 μm.

Liquid Developer A

| | |
|---|---|
| Undiluted solution of toner | 300 g |
| Octolife Zr12% (manufactured by Sumika | 0.5 g |
| Enviro-Science Co., LTD.) | |

The above materials were stirred using a stirrer (three-one motor BL600 (using disk turbine)) at 300 rpm for 5 minutes so as to obtain the liquid developer A.

The following liquid developer B and liquid developer C were obtained by the same method.

Liquid Developer B

| | |
|---|---|
| Undiluted solution of toner | 300 g |
| Octolife Zr12% (manufactured by Sumika | 3 g |
| Enviro-Science Co., LTD.) | |

Liquid Developer C

| | |
|---|---|
| Undiluted solution of toner | 300 g |
| Octolife Zr12% (manufactured by Sumika | 8 g |
| Enviro-Science Co., LTD.) | |

The conductivities of the liquid developers are shown in Table 1.

TABLE 1

| | Conductivity |
|---|---|
| | (pS/cm) |
| Toner A | 0.7 |
| Toner B | 17.4 |
| Toner C | 123.1 |

### About Measurement of Conductivity of Liquid Developer

Next, the method of measuring the conductivity of the liquid developer will be described.

### Measurement Device

A liquid developer, that is, a sample, was inserted between flat-plate electrodes and an AC voltage was applied to it so as to obtain impedance, thereby evaluating the conductivity of a toner.

As an impedance evaluation device, a high-speed voltage amplifier HVA800 manufactured by Toyo Corporation was combined to an impedance measurement system 126096 W type manufactured by Toyo Corporation.

A sample holder 12962 A type manufactured by Toyo Corporation was used in the flat-plate electrodes.

### Measurement Condition

A frequency range of 1 Hz to 100 kHz was measured with a gap between the electrodes of 300 μm and an applied voltage 200 V.

### Analysis of Measured Result and Calculation, of Conductivity

FIG. 6 was used as an electrical circuit for evaluating the measured result.

R2 and C2 respectively denote resistance and capacitor components based on the movement of the toner particles and R1 denotes a resistance component due to a carrier liquid and dissolved ions.

The conductivity 1/(R1+R2) of the liquid developer was obtained.

### About Configuration of Transfer Belt

Next, a detailed configuration example of the transfer belt 40 will be described. As the transfer belt 40, a multi-layer elastic belt shown in Table 2 having a three-layer structure of a base layer 140+an elastic layer 141+a surface layer 142 was prepared.

TABLE 2

| | | | Other (reference |
|---|---|---|---|
| | Material | Thickness | physicality value) |
| Base layer (140) | Polyimide | 100 μm | Young's modulus |
| | | | 2.8 GPa |
| Elastic layer (141) | Urethane rubber | 250 μm | Rubber hardness |
| | | | JIS-A30° |
| Surface layer | Fluorine-based | 10 μm | |
| (142) | resin | | |

In addition, by adjusting the additive amount of the conductive agent added to the elastic layer 141, the transfer belt 40 having resistance shown in Table 3 was obtained.

TABLE 3

| | Volume resistivity | Surface resistance |
|---|---|---|
| | [Ω · cm] | [Ω] |
| Belt A | 4.3 × 10⁸ | 1.8 × 10⁹ |
| Belt B | 7.5 × 10⁹ | 2.3 × 10¹⁰ |
| Belt C | 3.4 × 10¹² | 6.1 × 10¹² |

### About Configurations of Rollers of Transfer Apparatus

Next, the configurations of the rollers of the secondary transfer unit GO will be described. Those shown in Table 4 were used as parameters such as the materials and the dimensions of the driving roller (first roller) 41, the second roller 42 and the secondary transfer roller (third roller) 61.

TABLE 4

| | | | | Rubber | |
|---|---|---|---|---|---|
| | | Outer | Hard- | Thick- | Electrical |
| | Material | diameter | ness | ness | resistance |
| Driving roller | Metallic core | φ40 mm | — | — | — |
| (first roller) | | | | | |
| Second roller | Metallic | φ20 mm | JIS- | 2.5 mm | 10⁷ Ω |
| | core + urethane | | A30° | | |
| | rubber surface | | | | |
| | layer | | | | |
| Secondary | Metallic | φ60 mm | JIS- | 2.5 mm | 10⁷ Ω |
| transfer roller | core + urethane | | A45° | | |
| (third roller) | rubber surface | | | | |
| | layer | | | | |

| | |
|---|---|
| Width | Rubber width of secondary transfer roller: 330 mm, |
| relationship | transfer belt width: 350 mm |
| Nip | Circumferential length (W) of belt winding |
| composition | portion is 16 mm |

### About Method for Measuring Resistivity of Transfer Belt 40

The following methods were used in the measurement of the volume resistance and the surface resistance of the transfer belt 40. The measurement was performed under the following condition using Hirester UP manufactured by Dia Instruments Co., Ltd. as a resistance measurement device.

Probe=UR probe
Applied voltage=250 V
Measured time=10 sec

Next, Example 1, Comparative Examples 1 to 4 based the above-described setting will be described.

### Example 1

### Combination of Liquid Developer B and Belt B

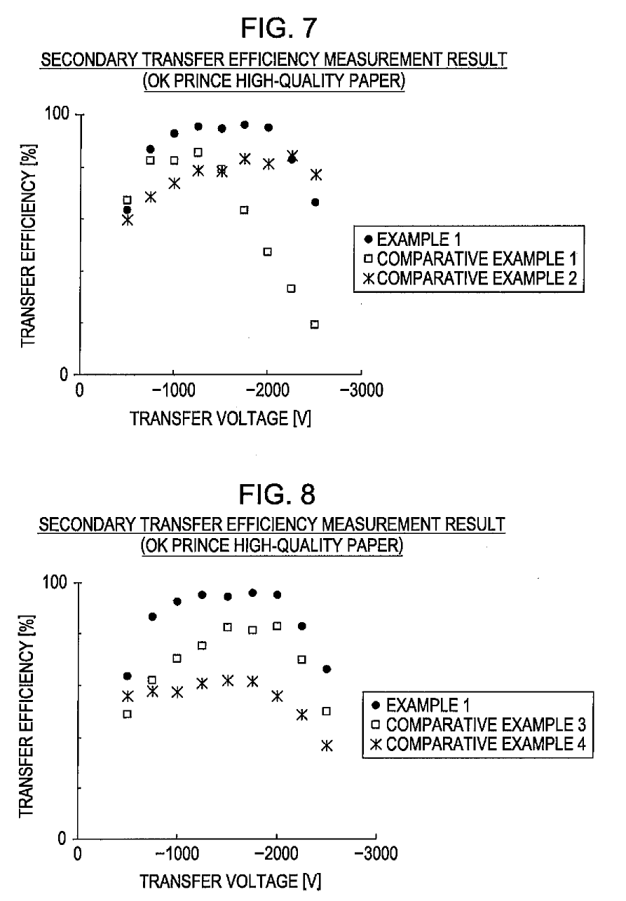

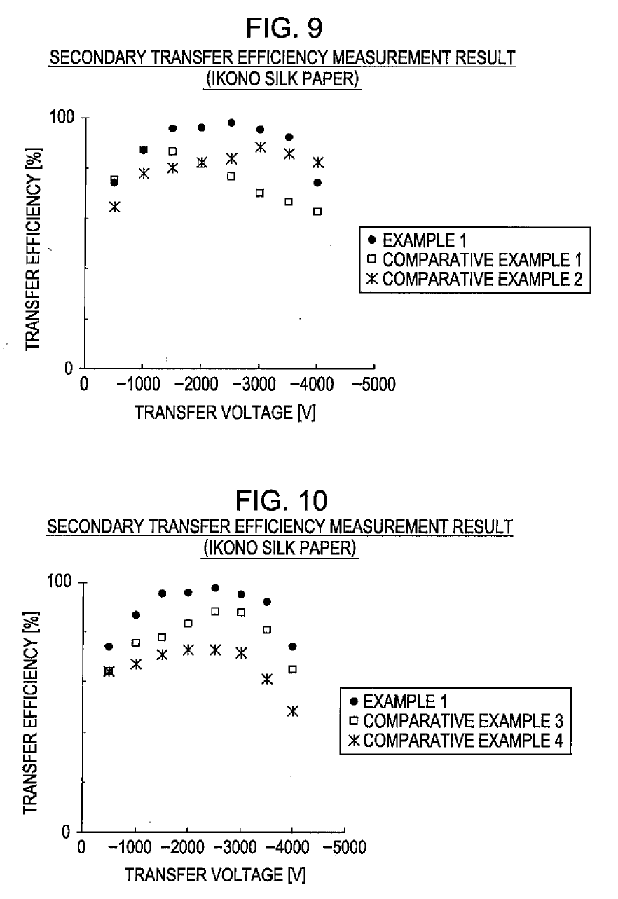

The transfer efficiency was measured with respect to Ikono silk paper (basis weight 135 g/m²) manufactured by Zanders and OK Prince high-quality paper (basis weight 81.4 g/m²) manufactured by Oji paper Co., Ltd., The transfer efficiency was measured while the transfer bias applied to the secondary transfer roller (third roller) 61 was changed so as to obtain the result of FIG. 7 (OK Prince high-quality paper) and FIG. 9 (Ikono silk paper).

The peak efficiency was about 96% in the OK Prince high-quality paper and was about 98% in the Ikono silk paper (good results were obtained).

### Comparative Example 1

### Combination of Liquid Developer B and Belt A

The result of Comparative Example 1 is shown in FIG. 7 (OK Prince high-quality paper) and FIG. 9 (Ikono silk paper). The increase in efficiency of the voltage was better than Example 1, but the reduction in efficiency was started at a voltage lower than that of Example 1. This is because the polarity of the toner particles is reversed due to injection of charges.

The peak efficiency was about 85% in the OK Prince high-quality paper and was about 87% in the Ikono silk paper.

### Comparative Example 2

### Combination of Liquid Developer B and Belt C

The result of Comparative Example 2 is shown in FIG. 7 (OK Prince high-quality paper) and FIG. 9 (Ikono silk paper). The increase in efficiency of the voltage was slow and the peak efficiency was lower than that of Example 1. This is because the polarity of the toner particles is reversed due to injection of charges.

The peak efficiency was about 84% in the OK Prince high-quality paper and was about 89% in the Ikono silk paper.

### Comparative Example 3

### Combination of Liquid Developer A and Belt B

The result of Comparative Example 3 is shown in FIG. 8 (OK Prince high-quality paper) and FIG. 7 (Ikono silk paper). The increase in efficiency of the voltage was slow and the peak efficiency was lower than that of Example 1. This is due to lack of charging amount of toner particles.

The peak efficiency was about 83% in the OK Prince high-quality paper and was about 88% in the Ikono silk paper.

### Comparative Example 4

### Combination of Liquid Developer C and Belt B

The result of Comparative Example 4 is shown in FIG. 8 (OK Prince high-quality paper) and FIG. 7 (Ikono silk paper). The increase in efficiency of the voltage was slow and the peak efficiency was lower than that of Example 1. This is because the conductivity of the toner particles is excessively high, excessive current flows in the secondary transfer portion, and, as a result, an electrical field is insufficient and the polarity of toner is reversed.

The peak efficiency was about 62% in the OK Prince high-quality paper and was about 73% in the Ikono silk paper.

The result of Example 1 and Comparative Examples 1 to 4 is shown in Table 5. In addition, the belt A has resistance lower than that defined in the invention, the belt B has resistance defined in the invention, and the belt C has resistance higher than that defined in the invention. The liquid developer A has conductivity lower than that defined in the invention, the liquid developer B has conductivity defined in the invention, and the liquid developer C has conductivity higher than that defined in the invention.

TABLE 5

| | Toner A | Toner B | Toner C |
|---|---|---|---|
| Belt A | — | Comparative | — |
| | | Example 1 X | |
| Belt B | Comparative | Example ◯ | Comparative |
| | Example 3 X | | Example 4 X |
| Belt C | — | Comparative | — |
| | | Example 2 X | |

Although various embodiments are described in the present specification, other embodiments configured by adequately combining the configurations of the embodiments are included in the invention.

What is claimed is:

1. A transfer apparatus comprising:
a transfer belt that has a volume resistivity of 10⁹ to 10¹² Ω·cm and carries a liquid developer including a carrier liquid and toner particles with conductivity equal to or greater than 1 pS/cm and equal to or less than 100 pS/cm in a first surface thereof;
a first roller that is grounded and is in contact with a second surface of the transfer belt;
a second roller that is in contact with the second surface of the transfer belt;
a third roller that is in contact with the first surface of the transfer belt and presses the first roller with the transfer belt interposed therebetween; and
a voltage source that applies a voltage to the third roller.

2. The transfer apparatus according to claim 1, wherein the surface resistance of the first surface of the transfer belt is 10^{9.5} to 10^{12.5}Ω.

3. The transfer apparatus according to claim 1, wherein the transfer belt has a base layer configuring the second surface and an elastic layer and a surface layer configuring the first surface.

4. The transfer apparatus according to claim 1, wherein the third roller presses the second roller with the transfer belt interposed therebetween.

5. The transfer apparatus according to claim 1, further comprising a second voltage source that applies a voltage having a voltage value equal to or substantially equal to that of a voltage applied to the third roller to the second roller.

6. The transfer apparatus according to claim 1, wherein the second roller is electrically in a float state.

7. An image forming apparatus comprising:
a latent image carrier on which a latent image is formed;
a charging unit that charges the latent image carrier;
an exposure unit that forms the latent image on the latent image carrier charged by the charging unit;
a development unit that develops the latent image formed on the latent image carrier by the exposure unit using a liquid developer including a carrier liquid and toner particles with conductivity equal to or greater than 1 pS/cm and equal to or less than 100 pS/cm;
a transfer belt with a volume resistivity of 10⁹ to 10¹² Ω·cm, in which an image developed by the development unit is transferred on a first surface thereof;
a first roller that is grounded and is in contact with a second surface of the transfer belt;
a second roller that is in contact with the second surface of the transfer belt;
a third roller that is in contact with the first surface of the transfer belt and presses the first roller with the transfer belt interposed therebetween so as to transfer the image on a recording medium; and
a voltage source that applies a voltage to the third roller.

8. The image forming apparatus according to claim 7, wherein the third roller presses the second roller with the transfer belt interposed therebetween.
